(19) United States
(12) Patent Application Publication
(10) Pub. No.: US 2005/0256677 A1
(43) Pub. Date: Nov. 17, 2005

(54) System and method for measuring the performance of a data processing system

(76) Inventors: Dennis P. Hayes, Tulsa, OK (US); Carey W. Neely, Tulsa, OK (US)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(21) Appl. No.: 10/844,080

(22) Filed: May 12, 2004

(51) Int. Cl. G06F 17/18

(52) U.S. Cl. 702/179

(57) ABSTRACT

The availability of a data processing system is measured on the basis of availability of each function of the system separately, rather than availability of specific machines or sub-systems. Also, aggregate availability figures are computed using weighting factors reflecting the importance of each function to the overall operation, and the relative quantity of usage of the function during different times of the day or week. Controllable interruptions in service such as for maintenance, are scheduled so as to ensure the availability of sufficient facilities for performing each function.

This invention relates to measuring the performance of data processing systems. In particular, this invention relates to measuring the availability of a data processing system for determining the performance of a service provider pursuant to a Service Level Agreement.

The Service Level Agreement (“SLA”) is an agreement, widely used in the data processing service industry, to set the standards that the service provider is contractually required to maintain in its operation of the data processing system for the customer.

Such agreements typically set standards required for such things as system or service availability, response time, time to identify the cause of and repair a customer-related malfunction, etc. Such agreements usually provide for penalties, often in the form of deductions from payments to be made to the service provider by the customer.

A problem which has existed for some time is that of just how to measure “availability”.

In the past, availability usually has been measured by determining the separate availability of each system or sub-system during a given time period. Often, the measure which has been used is “wall clock” availability, which is measured in terms of the percentage of the total time during each day in which a system or sub-system is available for operation.

Applicants have recognized that this measurement of availability, although it may be adequate in some cases, is not entirely accurate and, in fact, actually may be somewhat misleading, in terms of fulfilling the customer's needs. With the increase of distributed computing in the operation of many data processing systems, the availability or lack of availability of a given system or sub-system has a very complicated effect on the overall availability of the functions which the customer wants the system to perform.

Another problem has been that the computation of compliance with Service Level Agreement availability terms often has been done manually or with only partial automation. Thus, the process has been relatively labor intensive, slow and expensive.

Another problem has been that Service Level Agreement compliance often has required the exercise of subjective judgment of personnel. This can and has in the past led to disagreements and further efficiency-reducing wasted time of operative and administrative personnel.

A further problem has been a need for a reliable measurement indicating the aggregate availability of the data processing system for its desired purposes, over a substantial period of time, such as one month or one day.

The inventors also have recognized another need, and that is for providing availability figures which more accurately reflect the impact of service outages on the business of the user of the system.

An additional problem is caused by the need for properly scheduling maintenance and replacement of machines in a data processing system so as to maximize the availability of the system to the customer without creating excessive hardware or software costs, and yet providing adequate maintenance.

A still further problem is the need to account for the loss of performance data in transmission to a facility for computing performance figures and reports. This problem is exacerbated by the lack of synchronism of the elements of a very widespread data processing system such as that used by a business enterprise.

In addition, the inventors have recognized the need for the gathering and computing of forecasts of performance of the data processing system, based on actual performance data available for a sub-period of the desired time period for which the forecast is needed.

Accordingly, it is an object of the present invention to provide a system and method for alleviating or overcoming the foregoing problems.

In particular, it is an object of the invention of provide a system and method for measuring and reporting the availability of a data processing system on the basis which better reflects the actual needs of the system user.

In accordance with the present invention, these problems are met by the provision of a method and system for measuring the availability of the data processing system for performing each of several functions it is intended to perform. This is in contrast to the prior method of indicating the percentage of the time each platform was available. Thus, using the present invention, the customer will receive a measure of the percentage of time the system was available to compute each of a number of functions which are important to its business, rather than the availability of each of the different components of the system.

For example, in an airline operations data processing system, which usually is used both for processing passenger services such as reservations, and for processing flight operation functions, the most frequently required functions of the system are identified, and the availability of the system to perform each of those different functions is measured and reported.

The inventors also have recognized that an informative aggregate overall system availability measure is needed.

Therefore, in accordance with another feature of the present invention, applicants have provided a system and method for weighting the relative importance of the different functions, and then aggregating the availability figures, modified by the weighting functions, to give a more accurate and meaningful aggregate availability figure.

In accordance with a further feature of the invention, the data necessary for the various computations used in computing the availability figures is gathered automatically and is computed substantially without human intervention and bias. The invention makes use of the simple expedient of measuring the error messages received for each function, and measuring the total number of requests made for each function, and then subtracting the error messages from the number of requests and dividing the result by the number of requests, thus giving function availability figures automatically.

In determining the weight to be applied to each function in computing an aggregate availability figure, actual traffic is monitored, at regular intervals, for a period of time, (e.g., one week every six months) to determine the number of times each function was requested as a percentage of all functions requested.

Alternatively, and preferably, the number of requests for a function are measured continuously during each day and the weighting factor is determined by computing the percentage of total requests for all functions during the day.

In accordance with another feature of the invention, many of the functions to be performed by the system require the operation of two or more “machines” (computer hardware and software combinations) or “platforms” in order to perform the function. Traffic is monitored in the same way as described above to determine the percent usage of each of such machines during a particular function, so as to provide a weighting factor indicating the relative importance of that machine in the function. This factor also is used in computing an aggregate availability percentage.

Applicants also have recognized that the availability of the data processing system for performing the various functions changes from time to time during the normal business day.

For example, in an airline data processing system, the demand for performing many passenger reservation functions usually is much higher in the hour between 9:00 A.M. and 10:00 A.M. on a business day than it is in the hour between 3:00 and 4:00 A.M. Similarly, the demand for many functions varies significantly from day to day. Thus, the inventors have recognized that an availability figure weighting function requests during the heaviest traffic times is more valuable to the customer and fairer to both the customer and the service provided than one giving equal weight to data from all times of the day.

Accordingly, a further weighting factor is used in computing the aggregate availability of the system during a particular time period, such as one day or one month, etc.

The weighting factor for the time of day can be computed by measuring the request volumes during a test period, and then applying the weighting factors to actual data observed.

Alternatively, and preferably, the weighting factor is determined by counting the number of requests for a given function during a given relatively small time period such as one minute and dividing that count by the total count of the requests for that function for a larger time period such as one day. The latter weighting procedure has the distinct advantage of operating automatically to be self-adjusting, thus reducing the labor and time required to compute the weighting factors, and making the system quickly responsive to changes in the timing of the demand for service.

The system and method of the invention also provide a method for normalizing the transmission of performance data from various parts of a widespread system to a remote data processing facility for recording and computing performance figures. This is improved by compensating for the loss of data in transmission.

In accordance with the invention, the data transmitted from different parts of the system, each of which is controlled by a clock which is not necessarily synchronized with any other clock in the system, by providing a virtual clock forming “windows”, and fitting one and only one data packet into each window. If two or more data packets are received in a given time window, then the extra packet or packets is stored, and a subsequent time window is tested. If it is empty, the extra data packet is inserted into that time window so that it will not be lost. Thus, it is prevented from being counted as an error diminishing performance of the system.

In addition, data interpolation is provided for data packets containing variable numbers of function requests and error messages so as to provide a statistically correct approximation of the data despite the loss.

The invention also provides a method for forecasting the performance of a data processing system over a substantial period of time, e.g., one month, by measuring its actual performance for shorter periods within the longer time period, e.g., one or a few days, and then projecting the performance for the month based on the average performance actually measured at the time of measurement.

Alternatively, the projection can be based on other reports, such as the worst daily report or the best daily report to date. These predictions permit the system operator to take any steps that may be necessary to adjust such things as maintenance schedules, new equipment deployment, personnel employment, etc., to ensure the meeting of the required standards for the longer time period and avoid penalties due to sub-standard performance.

The foregoing and other objects and advantages of the invention will be set forth in or apparent from the following description and drawings.

### IN THE DRAWINGS

FIG. 1 is a schematic diagram of a data processing system in which the invention is utilized, the particular system shown being one for processing airline reservation and flight operation data;

FIG. 2 is a schematic diagram illustrating a system for gathering system performance data and processing it in accordance with the present invention; and

FIG. 3 is a block diagram illustrating a portion of the system shown in FIG. 2.

### GENERAL DESCRIPTION

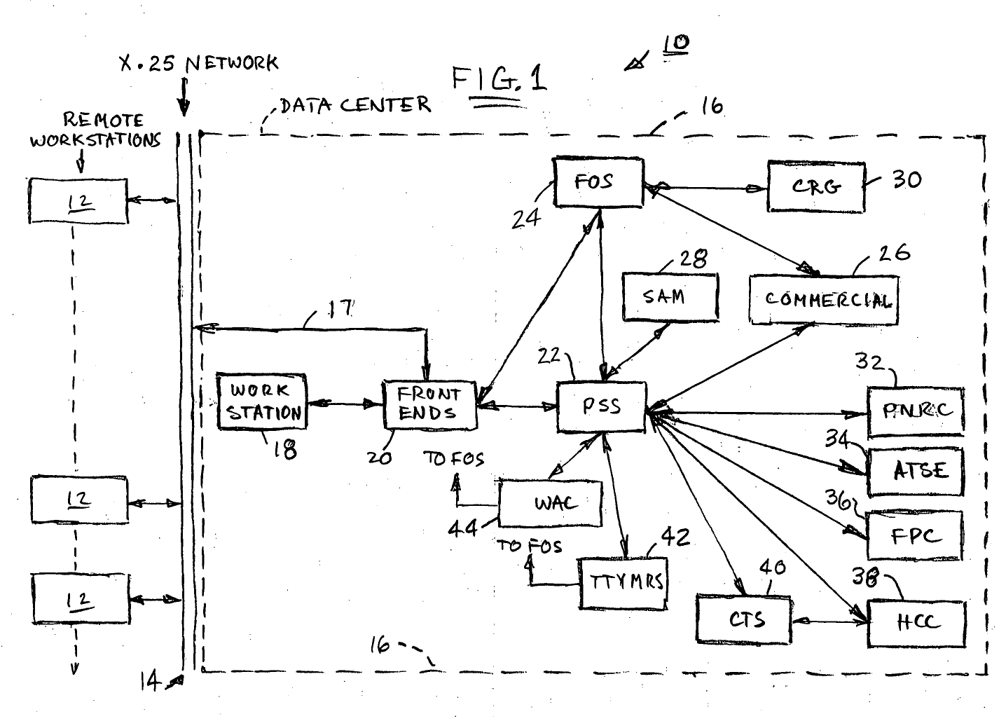

FIG. 1 is a schematic diagram illustrating an example 10 of a data processing system in which the invention is used. The system illustrated is an airline data processing system for handling passenger services and flight operations data. FIG. 1 also illustrates the infrastructure and some of the functions in the system from which performance data is gathered.

It should be understood, of course, that the system and method of the invention can be used to advantage in commercial, governmental, charitable, educational and enterprises other than airlines.

Shown at the left side of FIG. 1 is a plurality of remote work stations 12 by means of which requests for various functions are input by agents at workstations, for example, for the provision of passenger services or flight operations services. Such workstations can be located at many different places around the world, and can be very numerous. The workstations use a number of different applications programs for performing the functions required.

The output signals from the workstations are delivered through a private network, such as an X.25 network operated by a company such as SITA, or the World Wide Web, or equivalent networks offered by others.

The signals from the work stations 12 are delivered to a remote data center 16, which can be located either at one remote location or a number of different locations, as needed. Signals from the network flow through a path 17 to the respective front ends 20 of various mainframe or other computers. The front ends contain processors for consolidation, translation and managing of data.

A workstation 18 injects hypothetical “traffic” signals into the system to test the operability of the system, response time, etc., free from the effect of network transmission errors.

The remainder of FIG. 1 shows a number of sub-systems or “machines” (combinations of hardware and software) for performing some of the most important functions required in the operation of the system.

The operations are divided into two major groups; block 22 labeled “PSS” is the Passenger Service System, and block 24 illustrates the Flight Operation Systems “FOS”.

### Passenger Service System

The Passenger Service System “PSS” 22 includes a number of different “machines”, some of which are shown in FIG. 1.

Block 32, labeled “PNRC” is the Passenger Name Record Complex, in which various data is stored and retrieved in response to the input of a passenger name and request for records. This is a frequently used function in an airline reservation system.

Blocks 34 and 36, labeled “ATSE” and “FPC”, respectively, are two alternative sub-systems for determining the pricing of airline passenger fares. One or the other is used to supply fare information in response to requests from the remote work stations. This function also is frequently used.

Block 38, labeled “HCC”, is a Host Communication Complex, which works with the “CTS” unit 40, Common Translation Service, in another frequently-used function named Reverse Airline Availability (“RAA”).

RAA is a function which allows the determination of availability of seats on the flights of other airlines which participate in a cooperative venture with the principal airline to make other flight connections for passengers when the desired flight on the principal airline is not available. This involves connections to the networks of the cooperative airlines, as well.

Block 42, labeled “TTYMRS”, is a Teletype Message Routing System for handling messages from older reservation systems using teletype equipment.

Block 44, labeled “WAC”, is the World Access Complex which allows an agent in one country to represent another airline, and also collects weather information from the FAA, etc.

Block 28, labeled, “SAM”, is a Sales Alliance Manager system which, when accessed, can be used to search for favorable fares and special bargain rates for passengers.

### Flight Operating System

The “FOS” or Flight Operating System, as is well known, handles the telemetry and other matters relating to flight operations.

One sub-system of the FOS is represented by block 30 “CRG”. This is the Cargo system which provides best cargo routing in accordance with cargo guide rules for shipping.

Selected data is fed from both the “FOS” and “PSS” operations and is stored in an operation represented by block 26, “COMMERCIAL” in which data regarding billable activity by the data center operator and/or others is stored. In addition, the mileage accumulated by passengers under various frequent-flier mileage programs is stored and made available for recall.

With the exception of blocks 44 and 26, the blocks shown in FIG. 1 illustrate a few of the many different functions which are requested by agents at the remote workstations 12 and in response to which signals are delivered through the network back to the remote work stations.

Actually, in a typical airline data processing system, there are in the neighborhood of seventy different functions in the passenger service system, and around thirty-seven different functions in the flight operations system. However, only the most significant functions are monitored.

### General Procedure

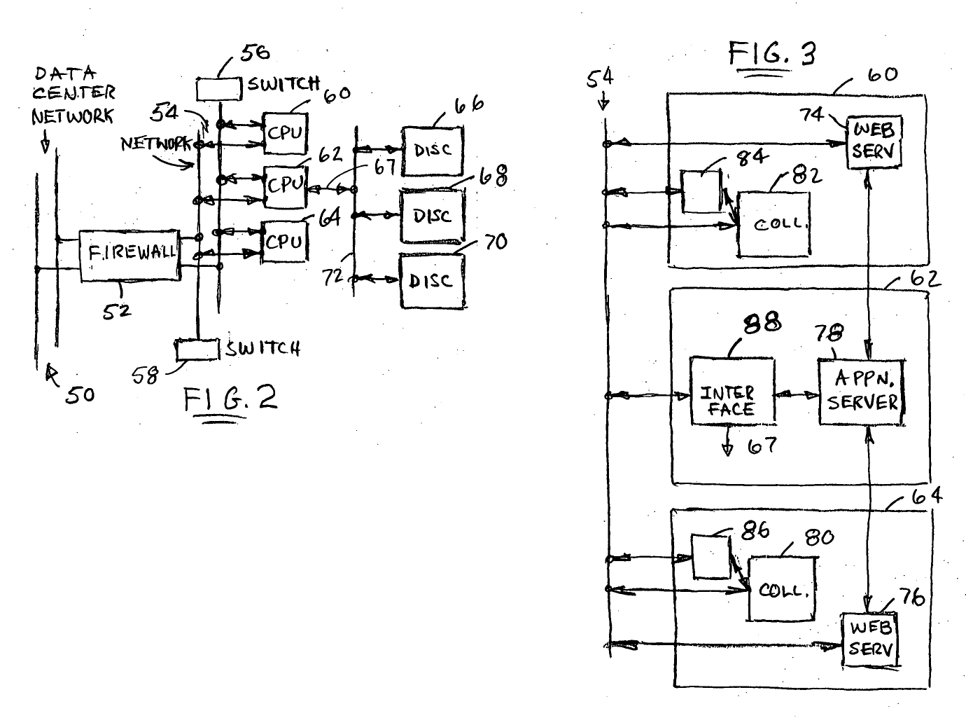

In accordance with the present invention, whenever one of the monitored functions is requested by an agent at one of the work stations, the data gathering system shown in FIGS. 2 and 3 of the drawings counts each request or “call” for a given function. In essence, when the function is not enabled, this failure is indicated to the agent as an error signal.

Sometimes the error is created by failure of the application software or processors, sometimes due to a network failure, and sometimes due to the failure of the equipment or software in the data center 16. Typically, the operator of each of the three facilities is responsible for its own errors, and not for the errors of the systems under the control of other operators. Thus, the types of error signals are distinguished from one another and only those attributable to the operator of the data center are counted.

Following is a table showing the various types of errors and the responsible party for each.

| | Function | | | | | | | | | |
|---|---|---|---|---|---|---|---|---|---|---|
| | | | | | | | | CTS | | |
| | | | | | | | | Seat- | HCC | |
| Type of | | | | CTS | | | | map | EIT | |
| Error: | FPC | PNR | SAM | Avail | DCA | FOS | NCI | MAP1 | SET | SCM |
| Timeout | CUST | CUST | CUST | OPR | OPR | OPR | OPR | OPR | OPR | CUST |
| Threshold | CUST | CUST | CUST | OPR | OPR | OPR | OPR | OPR | OPR | CUST |
| reached | | | | | | | | | | |
| Pseudo | CUST | CUST | CUST | OPR | OPR | OPR | OPR | OPR | OPR | CUST |
| Replies | | | | | | | | | | |
| Complex | OPR | OPR | CUST | OPR | OPR | OPR | OPR | OPR | OPR | CUST |
| Unavailable | | | | | | | | | | |

In the foregoing table, “CUST” stands for the customer, and “OPR” stands for the data center operator. Each party is listed to show what type of error in each function that each is responsible for.

Although the type of errors and how to detect them are well known in the airline industry, they will be explained briefly here.

“Timeout” is an error resulting when the time limit set for completing each function requested runs out.

“Threshold Reached” is an error resulting from overloading a function with more requests than the system can handle.

“Pseudo Replies” are artificial replies generated by the application software. They are given when the function is not available; they are corrected later.

“Complex Unavailable” is an error when one of the sub-systems needed for one of the functions is unavailable.

Only the errors labeled “OPR” are used in calculating availability for the data center operator. Outages attributable to scheduled downtime for maintenance or other necessary purposes are omitted from the calculations.

### Reports

In general, a number of reports on operations are given to the customer by the data center operator. These include response time, availability and other measures. However, this invention deals primarily with the computation of and reporting of availability.

Two types of availability reports are given; Aggregate availability, and function availability.

There are two types of aggregate availability; aggregate availability of the PSS system, and aggregate availability of the FOS system.

There is a separate function availability report given for each of the functions which is monitored. Only some of the functions are monitored, but the selection of which are to be monitored can be changed as needed. In general, only the functions considered to be most important to the customer's business are selected.

The computation of function availability will be explained first, because its understanding will facilitate an understanding of aggregate availability.

### Function Availability

In determining function availability, the number of failures attributed to the system operator is subtracted from the total number of requests or calls for a given function to provide a number of requests fulfilled successfully. Then, the performance percentage is computed by dividing the number of requests fulfilled by the total number of requests. This procedure is shown by the following equation:

$$A = ( M ) \frac{ {L}_{total} - {L}_{error}}{{L}_{total}}$$

where:
A=Availability, in percent, for one day.
Lₑᵣᵣₒᵣ Is the count of all actual errors which are attributable to the system operator, determined as described above. If multiple networks are used, as in the RAA function, the count includes all errors in all of the networks.
Lₜₒₜₐₗ is the count of all of the calls for the function for all networks in the time period (one day).
M is a factor which accounts for telemetry or transmission errors, and will be explained below.

In the foregoing equation, M is defined as follows:

$$\frac{{M}_{expected} - {M}_{bad}}{\underline{{M}_{expected}}}$$

where:
M_{expected}=1440*N 1440 is the number of minutes per day, and
N=the number of networks where the function is implemented
M_{missing}=M_{expected}−M_{received}
M_{bad}=Mₑᵣᵣₒᵣ+M_{missing}−O[T_{down}+T_{TPFdown}]
where:
M_{received}=the number of reports actually received
O[ ]=a function that computes the number of minutes of overlapped scheduled downtime
T_{down}=the time, in minutes, the application was scheduled down on all networks
T_{TPFdown}=the time, in minutes, the TPF computers (Translation Processing Facility computers, the main part of the computing facility) were scheduled to be down
The Mₑᵣᵣₒᵣ count is found by counting the number of test probes which failed in the time period. (See explanation of test probes below.)
M_{expected} is found by determining the total number of messages one would expect to receive from all networks.

The concept and further details of the system implementing the determination of M are discussed further below.

The foregoing computations are made and the performance figure “A” is given for each of the functions monitored after the end of each day.

### Aggregate Availability

The methods of computing PSS aggregate availability and FOS aggregate availability are basically the same except that the functions are different. The PSS availability computation will be explained and will be used to demonstrate the principles of both.

The general equation defining aggregate availability is:
AA=A_{(SYS)}·A_{(DNS)}
where
AA=aggregated availability, in percent
A_{(SYS)}=baseline availability of the PSS or FOS system
A_{(DNS)}=availability of the downstream system.

As noted above, front end processors 20 are used to consolidate and convert incoming signals from the remote workstations into a consistent protocol or format for use in the remaining portion of the system.

The front ends also transmit periodic test probes sent from the work station 18. For example, test probes, which are made to simulate actual real requests for services, are transmitted at periodic intervals, at least as frequently as one per minute and often more frequently.

In the particular front ends 20 used in the system shown in FIG. 1, three different front ends are used. One is based on a Microvax computer and software designed to handle X.25 network traffic. A second processor is connected up-line from the Microvax computer and converts signals from TCP/IP format to X.25 format. The third processor uses Unix hardware and software which allows TCP/IP format signals to proceed directly.

It should be understood that the provision of multiple front ends is not necessary to the invention; it is dictated primarily by the types of networks used, and it is feasible to have a single front end for operating with a single compatible network.

The first step in the process is to determine the “base line” availability of the PSS system. This is determined by counting the number of probe signals to which the system is unavailable and subtracting that number from the total number of probes sent. This computation is performed for each of the three front ends, and a weighting factor is applied to each, and the three figures, multiplied by their respective weighting factors are added together to give the base line availability of the PSS system. This provides the first part of the equation given above for aggregate availability. In essence, it is a determination of the availability of the various sub-systems in the PSS system.

Next, the downstream availability is completed.

For the purpose of this calculation, the downstream system comprises machines for performing the following functions; AVL, DCA, EIT, FOS, FPC, MAP, NCI, PNR, SAM and SCM, whose purposes are well known in the art.

The downstream availability then is equal to the sum of the requests made to each of the downstream systems minus the failures and errors actually experienced divided by the total requests.

Next, each separate function of the PSS system (called a “bucket”) requires one or more components or “machines” on which it is dependent for its operation. The availability for each bucket is made the sum of the availability of each of the components used in that bucket.

### Function Weighting

In addition, a weight is applied to each of the product buckets depending upon its relative importance in the operations of the customer's business, as it has been discussed briefly above. In general, this is done by test sampling the relative frequency of the functions on a periodic basis, say, once every six months.

A weight also is applied to each of the components or platforms in the buckets, the weight depending on the frequency of use of the platform in the bucket. This also is determined in the same test samplings.

Alternatively, and preferably, these weighting factors are determined dynamically, by counting the number of calls for a function or platform during a given time period, e.g., one minute, adding all of the calls for a given function or platform together, and dividing that number, at the end of each day, by the total number of calls for all functions or platforms. This makes the determination of the weighting factors automatic and variable, in accordance with variations in the system needs on a day-to-day basis.

### Time of Day or Date Weighting

One of the weighting factors used in computing aggregate availability is the time of day or date in or on which calls for the functions are made.

This gives weight to the fact that in some businesses, such as the airline business, many more calls for service are received in certain times of the day than in the others. For example, typically, airline reservation function requests are much heavier between the usually busy hours of 9:00 AM to 10:00 AM on weekdays than between 3:00 AM to 4:00 AM, in the middle of the night. The busiest periods vary from day to day. Therefore, by giving greater importance to the availability of functions during the busiest periods, aggregate performance is measured and reported on a basis that is most valuable to the customer, and fairest to both the customer and the service provider.

Thus, for example, if a system was providing all required functions smoothly during the busiest part of a given day, but faltered in the middle of the night, this probably would create relatively little detriment to the customer's business and should not count against the performance of the service provider nearly as much as if the failures of the system had occurred at the busiest times.

Therefore, when reporting aggregate performance figures, the availability of each function is weighted with a factor depending upon the time of day when the calls for the function were made.

One way in which this can be done is to run tests to determine typical usage patterns of the system, determine the time when each request was received, and apply a predetermined weighting factor to the request when it is recorded.

However, a preferred method is to count the total number of requests of calls for the function during a given relatively short period of time, such as one minute, and develop the weighting factor based on the ratio between the number of calls received in that minute and the total number of calls received for that function during a longer time period such as one day. In this manner, the weighting factor is automatically computed and automatically adjusts the weighting factor for actual experience.

If desired, separate time-related weighting factors can be used for separate regions covered by the network, or for separate airports.

This weighting not only is fairer to the service provided and the customer, but gives both the information necessary to make adjustments in the availability of equipment, by scheduling system maintenance, etc. This tends to maximize equipment usage and profitability of airline operations, and of the service provider.

### Final Aggregate Availability Computation

Finally, the availability of the PSS system is computed by multiplying the base line availability by the downstream availability, with the use of the weighting factors mentioned above.

The aggregate availability figure is believed to give a more nearly accurate picture of the effect of the availability of the data processing system on the customer's business than any previous measure.

### Performance Data Collection and Computing System

FIG. 2 is a schematic diagram of the system used to collect data and compute performance records for the infrastructure shown in FIG. 1.

The data regarding total requests and fulfilled requests is supplied over the data center network 50, which can be an Ethernet network, for example. The data is supplied through a firewall 52 which blocks the transmission of all but the relevant data.

The data then is delivered through a local network 54, also an Ethernet network, with network switches 56 and 58, to a plurality of computers 60, 62 and 64. Those computers can be mainframe computers or others such as “Sunfire” model 880 computers sold by SunMicrosystems. Data is stored in and retrieved from disc files 66, 68 and 70 through a line 67.

FIG. 3 is an enlarged view of the computers 60, 62, and 64 with various software modules illustrated. Modules 74 and 76 are web servers which cooperate with an application server 78 to provide web access to the performance data at all times. This access is permitted to authorized personnel only, for example, airline employees and data center personnel.

Also provided are software modules 84 and 86 which collect data by two different sets of rules, and collectors 80 and 82 for storage of the data so collected.

The application server 78 is a server such as that sold under the trademark “iPlanet” by Netscape. The application server 78 implements rules used for analyzing and reporting the data received.

Also provided is an interface unit 88, such as a DB/2-UDB which reads to and writes from the disc files 66, 68 and 70.

The collectors 80 and 82 save data collected as a back-up for the central storage units, if they are temporarily unavailable.

Two different web servers 74 and 76 are provided for redundancy purposes. They are units such as those sold under the trademark “iPlanet” by Netscape.

In operation, the data collection system illustrated in FIGS. 2 and 3 can be used to collect data continuously for any twenty four hour period (or other period) before analysis and reporting of the performance data takes place. Typically, analysis and reporting is done at the end of each business day, usually during the night time when other traffic is relatively light.

### Telemetry Normalization

This is a further explanation of the way in which the “M” factor in the equation for function availability is determined.

In the telemetry used in transmitting the performance data from the remote work stations to the storage and processing equipment shown in FIGS. 2 and 3, is subject to errors. Therefore, in some Service Level Agreements, performance standards are set for the errors in transmission or telemetry of such data.

It is an advantage of the invention that it is capable of operating without the various far flung components of the network being synchronized with one another. Thus, there are many different clock sources in use throughout the system. Each of those clocks is subject to “drift”, and the amount and direction of such drift seldom is the same for any two clocks. Thus, in accordance with the present invention, a single “virtual” clock is provided by a computer program in the data center, under the control of a local clock source.

In the transmission of performance data, the performance data first is accumulated, and later transmitted at approximately one minute intervals. Therefore, the virtual clock provides a series of time “windows” throughout each day (1440 per day). Most of the time, the data packets or reports are transmitted one to a window. However, if a window occurs in which no data is received, this is counted as a loss of data which detracts from the system performance record. Therefore, it is desired to minimize the number of empty time windows.

Also, if two or more messages appear in the same time window, this causes problems because it can be made to appear that the system performance is better than 100%. Therefore, this also should be avoided.

In accordance with the present invention, this problem is solved by first detecting in each time window whether more than one data message has been received. If so, the extra message or messages are stored. The subsequent window then is tested. If a data message was not received within that time window, the extra data message stored is inserted into that window. If that window happens to be full, then the data message is dropped.

In this way, the error rate in the telemetry of the performance information is minimized.

The way in which these error factors are used in determining availability is shown by the equations given above. The factor “M” is computed and used to multiply the availability figures for each function.

### Data Interpolation

The performance data that is transmitted to the data center usually is in two different forms; in one form, the Report consists essentially of a “yes” or a “no”, and in the other, the report consists of a count of the total requests for a function and a total number of errors or failures to supply the request.

Data in the latter form often contains a substantial number of requests and errors. Therefore, the loss of any such report in transmission to the data center can create an error sufficient to require interpolation in order to avoid significant inaccuracies.

In accordance with another feature of the present invention, interpolation of data of the latter type is done as follows. The number of such reports which are sent and the number actually received at the data center are counted. Then, the total number of requests for the function which were made in the reports actually received at the data center is computed, and the total number of errors in those reports is computed and the ratio of the number of requests less the number of errors divided by the total number of requests is multiplied by the ratio of the total number of reports received divided by the total number of reports sent. An example follows.

It is assumed that three reports are sent: The first report has fifty requests and two errors; the second report has twenty-five requests and four errors; and the third report has twenty-five requests and one error. Assume that the third report is lost. Then, the total number of requests actually received is seventy-five and the total number of errors actually received is six. Therefore, the performance actually reported can be computed by dividing seventy-five minus six or sixty-nine by seventy-five, or ninety-two percent.

Since two out of the three reports sent were actually received, the ninety-two percent figure is multiplied by two-thirds to give a statistically correct count.

In actual practice, the numbers usually are much larger and a very high percent of reports sent are actually received so that the foregoing example is not a representative example of actual results achieved.

In any event, the interpolation method produces a statistically accurate method of interpolating the data in question.

### Machine Group Availability

In accordance with another aspect of the present invention, by defining availability on the basis of the functions to be performed, rather than on the availability of individual pieces of equipment and systems, it is possible to ensure the availability of the group of “machines” necessary to perform each function.

Most equipment and software at the data center requires periodic maintenance and replacement. Maintenance and replacement and personnel changes, etc., should be scheduled so as to minimize the impact of the downtime required on the customer's businesses.

In the present invention, this is done by first separating the “machines” into groups based on the functions the perform. That is, the combination of hardware and software which is needed for the performance of each function is classified as a “group”.

Next, the expected number of calls for that function for a given time period is determined on the basis of the test measurements described above. This defines the expected need for the machines in each group at various times of the day or week. For example, if it is determined that eleven machines will be required to process the expected volume of calls on a “group” between 9:00 and 10:00 AM in a given day, then maintenance and other such activities scheduled so as to assure that availability.

### Performance Projections

Another feature of the invention is the computation of performance projections in any time period based on actual performances early in the same time period.

Specifically, aggregate availability figures are given on a monthly basis. It is important for the system operator to be able to make the performance goals for each month. The timing of some events, such as scheduled maintenance, personnel changes, equipment and upgrades, and other factors are largely within the control of the system operator. The system operator can ensure meeting the month's performance goals if it is known early enough what level of performance is required.

In accordance with this invention, the performance figures for days early in the month automatically are analyzed. At any particular time, the performance figures for the days to date in the month will give an indication of the aggregate figures for the month. In addition, the performance figures for lowest performance and highest performance figures for any given day to date can be used in forming a projection of the whole months performance, by assuming either the worst or the best figures are obtained for the rest of the month.

Thus, each day, a new month-to-date aggregate performance figure is provided to enable management to make whatever adjustments are necessary to ensure the desired monthly figures will be reached.

For example, on the 10th day of a month, if the aggregate PSS availability to date is 99.2%, the worst day's figure to date is 98.6%, the best day's figure is 99.9%, and the goal for the month is 99.1%, the monthly figure can be projected by assuming alternatively the best and worst day's figures for the rest of the month to help in determining what steps are needed to meet the month's goals.

These calculations can be performed automatically on a daily basis, or even more frequently by simply programming the data or collection system computers.

### Protocols and Program Languages

In the system shown in FIGS. 1, 2 and 3, various communications protocols are used. For example, as noted above, X.25 protocol is used, as well as AX.25; TCP/IP; and various varieties of International Air Transport Association (IATA) host-to-host protocol for communications also are used.

The programming of the computers and other equipment in the system is straightforward, once the principles stated above are known. In an existing system, constructed in accordance with the invention, the front end systems use assembly language or “C” and assembly, “C” or “C++” or Java language are used elsewhere. The assembly language used is the standard language used in the airline industry for TPF.

The above description of the invention is intended to be illustrative and not limiting. Various changes or modifications in the embodiments described may occur to those skilled in the art. These can be made without departing from the spirit or scope of the invention.

1. A method of measuring data processing system performance, comprising:
(a) gathering request data regarding requests for each of a plurality of functions of a data processing system;
(b) gathering data regarding all correctly processed requests to supply each of said functions; and
(c) determining the percentage of the total requests for each function which was correctly processed.

2. A method as in claim 1 in which said functions are selected from the group consisting of: airline reservation functions and airline flight operation functions.

3. A method as in claim 1 including the steps of:
assigning a weight to each of said functions according to the relative importance of each of said functions to the use of said system, and
computing an aggregate performance figure for said weighted functions.

4. A method as in claim 1 in which at least one of said functions requires the operation of a plurality of different computer sub-systems.

5. A method as in claim 1 in which said gathering of request data comprises counting, in a given time period, the number of entries in said system of code indicating a request for a predetermined function, in which said gathering of data regarding correctly processed requests comprises counting the number of error messages received in said time period in response to the requests for said function and subtracting that number from the number of requests.

6. A method as in claim 1 in which said percentage is used to measure availability in determining system performance pursuant to a service level agreement for providing data processing services.

7. A method as in claim 1 including the steps of:
assigning to each message or group of messages received during a given time period during each day requesting said functions a weight which is a direct mathematical function of the number of such messages expected during that time period as a percentage of the total number of such messages expected for the day, and
computing an aggregate performance figure for said weighted functions.

8. A method as in claim 1 including the steps of:
assigning to each message or group of messages received during a given time period during each day requesting any of said functions a weight which is a direct mathematical function of the number of such messages received during a pre-determined time period during each day as a percentage of the total number of such messages received during that day, and
computing an aggregate performance figure for said weighted functions.

9. A method as in claim 8 in which said functions are selected from the group consisting of: airline reservation functions and airline flight operation functions.

10. A method as in claim 8 in which said predetermined time period is selected from the group consisting of approximately one minute and approximately one hour.

11. A method of operating a computer system for performing a plurality of data processing functions, said method comprising:
(a) determining the group of machines in said system required for performing each of said functions,
(b) determining the number of such groups needed to perform each of said functions at each of a plurality of times during each day, and
(c) ensuring that the required number of groups is available for performing each of said functions when required.

12. A method as in claim 11 in which said ensuring step includes scheduling maintenance for each of said machines in a group so as to ensure that the number of machines taken out of service does not reduce the total number of machines available in the group below the minimum number needed for the function at any time.

13. A method as in claim 11 in which each of said machines comprises a combination of computer hardware and software units distributed among a plurality of different units at at least one processing center, with said system including a plurality of remote input/output units connected to said machines through a network.

14. A method of communicating and recording data from widespread parts of a non-synchronous data processing system, said data relating to the availability of said system during specific time periods of its operation, said method comprising:
(a) transmitting said data to an accumulation location from a plurality of different sources at a rate controlled by a plurality of independent clock sources,
(b) normalizing said data by establishing a series of time windows for receipt of said data,
(c) detecting whether each individual group of data is received within a selected one of said time windows, and
(d) storing said group and delivering said data from said group in another of said time windows.

15. A method as in claim 14 in which said detecting step comprises detecting whether more than one group of data is received in one of said windows, and, if so, delivering the second of said groups during the next time window, if it does not already contain one of said data groups.

16. A method of interpolating availability data in a computer system, in which said data comprises separate groups of data transmitted separately over a period of time, each of said data groups including a variable number of calls for a given function and the number of those calls which were fulfilled,
(a) determining a first ratio of the number of successful transmissions of said data to the total number of said transmissions, and
(b) multiplying said first ratio by a second ratio comprising the total number of fulfilled calls divided by the total calls for said function in said time period, as reported.

17. A method as in claim 16 in which each of said functions is an airline passenger service or flight operations function.

18. A method of forecasting the performance of a data processing system for a given time period at a selected time before the end of said given time period, comprising:
(a) measuring the actual performance of the system at the end of each of a plurality of sub-periods of time prior to said selected time,
(b) measuring the overall performance of the system during said given time period up to said selected time,
(c) projecting the performance of said system over a future portion of said given time period based on a performance figure for a period selected from the group consisting of:
(1) the worst performance of any of said sub-periods;
(2) the best performance of any said sub-periods; and
(3) the overall performance of the system during all or part of the time period up to said selected time.

19. A method as in claim 18 in which said data processing system is an airline data processing system; and said given time period is one month, and said sub-periods are days during said month.

20. A method as in claim 19 in which said performance measurements are measurements of the availability of data processing functions.

21. A system for measuring the performance of a data processing system, said data processing system comprising a plurality of remote input/output terminals at which function requests are input and responsive information is delivered, at at least one data center at which is located at least one computer and data storage facilities, and a network for connecting said remote terminals to said data center,
(a) a plurality of different machines at said data center, each of said machines comprising computer hardware and software for performing a given data processing function, and
(b) apparatus for detecting the number of requests made for each of a plurality of pre-determined functions, detecting the number of the requests for each function that were fulfilled, and dividing that number by the total number of requests for the function to give a performance measure.

22. A system as in claim 21 in which said remote input/output terminals are airline agent terminals, and said function requests are for airline operation functions.

23. A system as in claim 21 including means for applying a weighting factor to the data relating to each of said functions in accordance with the frequency with which the function is requested.

24. A system as in claim 21 including means for applying a weighting factor to the data relating to each of said functions in accordance with the time of day at which the function is requested.

25. A system as in claim 21 including means for applying a weighting factor to the data relating to each of said functions in accordance with the ratio of the number of requests for said function in a given time span to the total requests for said function in a longer time span.

26. A system as in claim 25 in which said given time span is one minute and said longer time span is one day.

27. A system as in claim 21 including data storage means for storing data received over a period of time, and means for periodically computing performance figures from the data stored.

28. A system as in claim 21 including at least one web server for delivering to users of said system, through said network, signals for displaying data indicating said performance measure.
